(19) United States
(12) Patent Application Publication
(10) Pub. No.: US 2010/0201614 A1
(43) Pub. Date: Aug. 12, 2010

(54) Method and Apparatus for Computer Interface

(76) Inventor: Andrew Cohen, Western Australia (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 11/994,985

(22) PCT Filed: Jun. 30, 2006
(86) PCT No.: PCT/AU06/00917

§ 371 Date: Feb. 10, 2010

(30) Foreign Application Priority Data
Jul. 15, 2005 (AU) 2005903763
Aug. 12, 2005 (AU) 2005904372
Aug. 23, 2005 (AU) 2005904572
Mar. 27, 2006 (AU) 2006901546

(51) Int. Cl. G09G 5/00

(52) U.S. Cl. 345/156

(57) ABSTRACT

A physical user interface is provided for a microprocessor device that runs an operating system. The interface has an array of sensors located below a workspace having a housing. The workspace divided into regions that are visible to a user, each region signifying a command to or an action performed by the operating system. Counters are provided with stored information such that the counter can be interpreted by the physical user interface so as to indicate a location of the counter as well as the stored information. The information may be directly or indirectly indicative of a request for a URL.

This application incorporates the Applicant's co-pending PCT application PCT/AU2005/00173 and the Applicant's Australian provisional specifications 2004900759, 2004901455, 2005903763 and 2005904572.

### FIELD OF THE INVENTION

The invention pertains to human-machine interfaces and more particularly to a physical interface between a user and a computer or other electronic device or electrical appliance having a microprocessor and an operating system.

### BACKGROUND OF THE INVENTION

The present application deals with the interface to and control of electronic and electrical devices and appliances by way of a physical user interface. The term ‘physical user interface’ used herein refers to a means to control all or some of the functions of a machine by way of a tangible device or a space equipped to detect the presence, position, information content, removal and/or movement of one or more uniquely identifiable objects, where each such determination may be indicative of a command from a user to the machine, and which is connected directly or indirectly to the machine by way of one or other or a combination of a wired and a wireless link. The word ‘machine’ used herein refers to computers, consumer electronic products and electrical appliances including, but not limited to computers, televisions, mass data storage devices, video recorders (both VCRs and digital recorders), home networks, home automation systems and remote appliance control systems that include a microprocessor and an operating system.

The typical interface to even a moderately complex machine and the typical control device that accompanies the interface frequently involve a degree of complexity that is not easy for certain classes of users to comprehend, and/or require a degree of dexterity beyond that of some users. So, typical interfaces and control devices are frequently not suitable for a young child, the elderly, those unaccustomed to the technology and some physically or mentally challenged adults. However, some in these same classes of users have sufficient cognitive skills, spatial orientation and dexterity to use toys such as blocks, toy soldiers and checkers. Equally, a typical interface (with or without any associated pointing device) often requires fine motor skills and/or good eyesight for frequent and repetitive tasks, such as those customarily required to start, stop, calibrate and alter the functions of the machine(s) to which the interface is attached. This can be a source of frustration and strain for users.

Further, an interface to a complex device my require comprehension of numerous commands or a command language. In these situations it would be preferred to provide the user with an interface that is more graphic, or more tactile or symbolically more powerful than the conventional interface. The simplicity provided by such an interface can have benefits in promotional programs, loyalty schemes and business methods that utilise computer networks to communicate with customers.

Further, some interface devices are either immutable or not easily customisable to suit the needs of an individual user or an individual application.

Further some interface devices lack any sense of fun. Likewise many interface devices do not provide the user the comforting sense of correlation between a physical action of the user and events on a machine controlled by the interface device.

And finally, most interface devices do not concurrently act also as data communications devices capable of delivering data to and receiving data from an application on the machine attached to the interface device and thereby facilitating relatively complex data processing functions without additional user input.

### OBJECTS AND SUMMARY OF THE INVENTION

The present invention seeks to provide an interface to a machine that is appropriate and easily customisable to the abilities and needs of younger children, the elderly, the disabled or inexperienced or non-expert users and those users seeking a more productive, quicker means of controlling a machine.

Some embodiments of the invention are adaptable to methods of implementing promotional or loyalty programmes or other online business methods.

In some embodiments, the present invention also seeks to provide a physical interface to a machine, having a workspace that represents one or more commands that the user can issue to a machine using counters and that is easily changeable, both in appearance and functionality without fundamentally altering the physical device. The term ‘workspace’ used herein refers both to a two dimensional surface or combination of surfaces of any shape or orientation and to a three dimensional space of any shape or orientation. The limits and any internal divisions of the workspace may be physically defined in 2 or 3 dimensions (including printed lines) or may be displayed on an electronic display device or even projected onto or implied on a surface or in a space. A workspace may be of any size.

Accordingly there is provided a physical interface having a workspace, and an associated electronic system consisting of one or more sensors (in any arrangement) capable of detecting the presence and position (and optionally the orientation) of one or more objects in the workspace. The term ‘object’ used herein refers to a physical object of any size and any material, particularly RFID tags, and may even include a person or other living thing capable of being placed in or entering the workspace and of moving or being moved within the workspace. The workspace may consist of a single region or may be subdivided (or sub-divisible automatically or by some user action) into regions separately detectable by the one or more sensors. The representation of the regions in a workspace may be actual (eg printed on material that forms part of the workspace), implied (e.g. represented by imaginary lines between two or more points on the perimeter of the workspace) or virtual (eg only visible or active when power is available to the physical user interface). An actual representation of regions in a workspace may be two dimensional (eg printed) or three dimensional (eg raised or recessed borders).

The physical user interface is connectable to one or more machines. One or more uniquely identifiable counters (physical objects) may be provided. A counter is capable of fitting within a region in or on the workspace (which may or may not be visually and/or physically defined) and each counter is detectable by one or more of the sensor(s) scanning the workspace in a way that identifies its location and distinguishes it from other counters. Collectively, the sensors can determine which region a counter is in. The workspace has a first appearance but optionally can be changed to have at least a second appearance.

In at least one embodiment the workspace may consist entirely or partially of an electronic visual display system and may be re-configured dynamically so as to re-define the number, size, shape and location of all or any regions.

In another embodiment the workspace may consist entirely or partially of a mechanical display system consisting of an actual definition of the limits and divisions of the workspace and may be re-configured manually with another, different mechanical façade so as to re-define the number, size, shape and location of all or any regions.

In some embodiments, a signal processor in the physical user interface uses the output of the sensors to determine the region of each counter and the identity of each counter and communicates the position and identity data as a first output signal to a control program. The control program may be running on the physical user interface device or on the machine with which the physical user interface device is associated. The control program turns that first output signal into a second signal that is capable of being interpreted by a machine as one or more commands.

In some embodiments the second signal output by the control program may consist partially or entirely of a video signal or data capable of generating a display on a visual display device such as a television set, PC screen or video monitor.

In some embodiments, a control program provides commands, based on sensor data. Examples of commands are to commence, cease or in some way alter the operating properties of the machine, or of some function of the machine, or of some application running on the machine associated with a counter.

In some embodiments, the commands provided by the control program may constitute commands to a further control program or operating system residing on the machine. In some other embodiments, the commands provided by the control program shall consist of switching signals, turning machines on and off and/or adjusting features of the operation of the machine, with or without any associated visual display on the machine.

In a further embodiment, the sensor or sensors also detect an orientation of a counter and the signal processor uses the orientation as well as the location and identity data to generate the first output signal.

In another embodiment, the façade (displaying the actual representation of the regions) contains, or is connected to or is in communication with a façade data storage capacity (memory), and is in communication in a uni-directional or bi-directional manner with the control program. The memory may be pre-loaded ex-factory. If pre-loaded, the façade data may be deleted once read by the sensors and the control program, or the data may be permanent and non-erasable. Further, in appropriate cases, façade data may be downloaded from a machine to the memory and stored for later use of that facade. The downloaded façade data may be permanent, transient (present until over-written or erased), or ephemeral (deleted the next time the counter data is read by sensors). A combination of permanent, transient, and ephemeral data may co-exist in the memory of a single façade. The downloaded façade data may contain data to be displayed on the machine and/or instructions to be executed by the machine alone or in combination with other data already on the machine. In one embodiment the façade data may contain (solely or in addition to any other façade data) an instruction to the machine to download further data from a web site or a removable storage medium, or to load additional data from the machine's memory and to run that data (either alone or in association with other façade data) with that façade and/or counters placed on that façade.

In some embodiments, counters may be transferable from a physical user interface connected to a machine to a similar or compatible physical user interface connected to another machine. For example, the association recorded ex-factory between a counter and a machine or function of a machine could allow the user to control a similar machine connected to a second, similar physical user interface. Furthermore, the data recorded on a counter by one machine or interface could be used on another machine or another, similar physical user interface.

In some embodiments, counters may contain memory capable of storing data to be read by the physical user interface and communicated to the control program. The types of data stored on the counters include, but are not limited to, a) security keys or passwords; b) settings, properties, and data associated with a specific functions of machines; c) player profiles, login data and personal avatars for games, instant messaging, etc.; d) applets or other applications; e) text strings or files; and f) hyperlinks.

In a further preferred embodiment the control program or some other application in communication with the control program can write data to the memory of a counter.

Some embodiments provide a method for distributing data where an operator provides stored information on a physical counter of a kind that can be interpreted by a physical user interface connected to a user's machine. The interface is adapted to indicate a location of the counter as well as retrieve the stored information. The information is directly or indirectly indicative of a URL. Data is distributed from that URL to the user's machine as a result of the user using the counter with the interface.

In yet other embodiments, a physical user interface is provided for a microprocessor device that runs an operating system. The interface has an array of sensors located below a workspace having a housing. The workspace is divided into regions that are visible to a user, each region signifying a command to or an action performed by the operating system. One or more counters are uniquely identifiable by the sensors, and each sensor produces a recognition signal. Also provided is a signal processor for determining, from the recognition signal, the identity of a token and the region that the token is in and producing an associated first output; and a control program for turning the first output into a second output that is capable of being interpreted by the operating system as a command. The housing has physical features for mechanically interlocking with and thus retaining a plurality of like counters.

### BRIEF DESCRIPTION OF THE DRAWING FIGURES

FIG. 1 is a triangular surface arrangement of a workspace of a physical user interface.

FIG. 2 is a perspective view of a physical user interface and interchangeable workspace.

FIG. 3 is a top plan view of an interface device for use with an interchangeable workspace.

FIG. 4 is a schematic view of a physical user interface.

FIGS. 5a & 5b illustrate two types of workspaces.

FIG. 6 is a top plan view of a type of workspace.

FIG. 7 is a top plan view of a keyboard device combines with a workspace.

FIG. 8 is a top plan view of a laptop computer incorporating a workspace.

FIG. 9 is a top plan view of a laptop computer incorporating another workspace.

FIG. 10 is a plan view of another workspace.

FIG. 11 is a plan view of another alternate workspace.

FIG. 12 is a cross section view of a path.

FIG. 13 is a cross section view of a depression above an active cell.

FIG. 14 is a perspective view of an interface with recesses for storing counters.

FIG. 15 is a perspective view of a counter; and

FIG. 16 is a flow chart illustrating uses of the invention.

### BEST MODE AND OTHER EMBODIMENTS OF THE INVENTION

As taught by the above referenced co-pending applications, one embodiment of a machine interface device comprises a case having a flat or gently curved, smooth, impermeable top surface. This surface is deemed a workspace. In the context of this invention, a counter 14 is a physical counter that can be detected, located and optionally read and/or written to (together “interpreted”) by one or more sensors that scan, read or interrogate the workspace. A workspace may also be a region of space bounded by appropriate sensors or alternately, two or more layers of surfaces operating cooperatively.

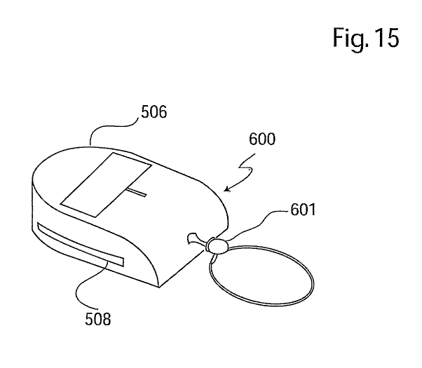

The counters may be in a portable form. One example is a counter in the form of a key ring (see FIG. 15). Another example is a player counter or counter included in a game, or provided or purchased separately from the game. In these examples, the portable counter could represent an avatar in an associated application game that is updated during play or could be part of a commercial loyalty scheme and used to transport data between the user's machine and the merchant's premises (and vice versa). In another example, when a counter is removed, it contains status information so that a computer game can be continued at a later time.

In another example, a security key is stored on a counter. An associated application is protected by a password, so that the application will not run or will not continue until the user places the counter on the surface and the password entered by the user agrees with or combines with the security key so as to indicate that the user is verified.

A counter may have multiple orientations. An orientation is a stable position in which a counter can be read by a sensor in a way that provides data unique to that orientation. To accomplish this, an orientation may be unique to that face of a polyhedron or other solid shape that is face down on the workspace 10. Thus, an RFID chip or other readable feature needs to be associated with each face that is intended to signify an orientation. An orientation is said to be stable if the counter is mechanically stable on or in the workspace and a unique output is rendered by the sensor. Where RFID chips are used, each RFID transmitter in a counter can be isolated from the others by magnetic shielding or by tailoring the transmission energy of the RFID chip or the read sensitivity of the sensor.

Each spiral element in a preferred RFID antenna array contains a tuned loop antenna circuit and a switch. The antenna switches are low capacitance, types connected to an RFID transceiver. One suitable transceiver is the type S6700 Multi Protocol Transceiver provided by Texas Instruments. It operates on a frequency of 13.56 MHz. This is a low power consumption device and supports multiple RF communication protocols. The maximum radiator power is about 200 mW at 5V. The communication interface is serial. The transceiver chip supports an ISO 15693-2 protocol. The ISO 15693-3 protocol required to interrogate the RFID markers is implemented in the firmware. The interface draws its power from the USB bus.

The antenna array is scanned from sequentially in a designated order. Every time a new antenna is selected, the interface will wait for about 1 ms for the tag to energise and then it will send the Read Signal Block 0 command. For more details, see standard document ISO 15693-3. If there is no tag present in the vicinity of the selected antenna, the firmware will wait for 2 ms and then select the next antenna and repeat the interrogation process. If a tag is present, it will respond by sending 1, block (4 bytes) of data. The first received byte contains the tag ID. The valid range is from 0 to 255. If necessary, the tag ID storage can be extended over a number of bytes and the number of supported markers will increase accordingly.

In one implementation the interface device may write a new tag ID to a tag. A new ID written by a device may be unique to the device and/or the machine with which it is associated, or unique globally. An ID written to a tag may be left open (able to be over-written) or may be permanently write-protected.

The firmware stores all current tag IDs into an ‘n’ byte arrangement that is sent to the host computer via the USB bus upon request (where ‘n’ equals the number of antennae in the array). The tag interrogation protocol includes the CRC error correction algorithm specified by standard ISO/IEC 13239 to protect against noise, interference and corrupt messages. The firmware in the reader and the tag calculates the CRC16 for every message sent and received. All messages with incorrect CRC16 are ignored.

The USB communication mode is high speed (12 Mbps). Data is sent to the machine via 1 USB pipe from Endpoint 1 (EP1). (Other communication links are possible instead of USB, such as Wi-Fi or a LAN connection) To ensure a guaranteed and timely data delivery EP1 mode is “interrupt”. The selected polling interval is preferably 2 ms. The RFID scanning routine is interleaved with the USB routines. The content of the tag array is sent to the computer after each and every antenna interrogation is completed. This will ensure a minimum delay between the user placing or moving a counter on the interface and the corresponding ID being sent to the host computer.

To allow for future features expansion, the data packet starts with a header. The first byte in the header contains flags. If the most significant bit is set (first byte=0x80), the following succession of data bytes carries tag ID information. The remaining bits are reserved for future editions and are currently 0. The second byte contains the length of the data packet, which is in the present example 36.

The total length of the data packet is 2 bytes (header) plus 36 bytes (data), providing a total of 38 bytes.

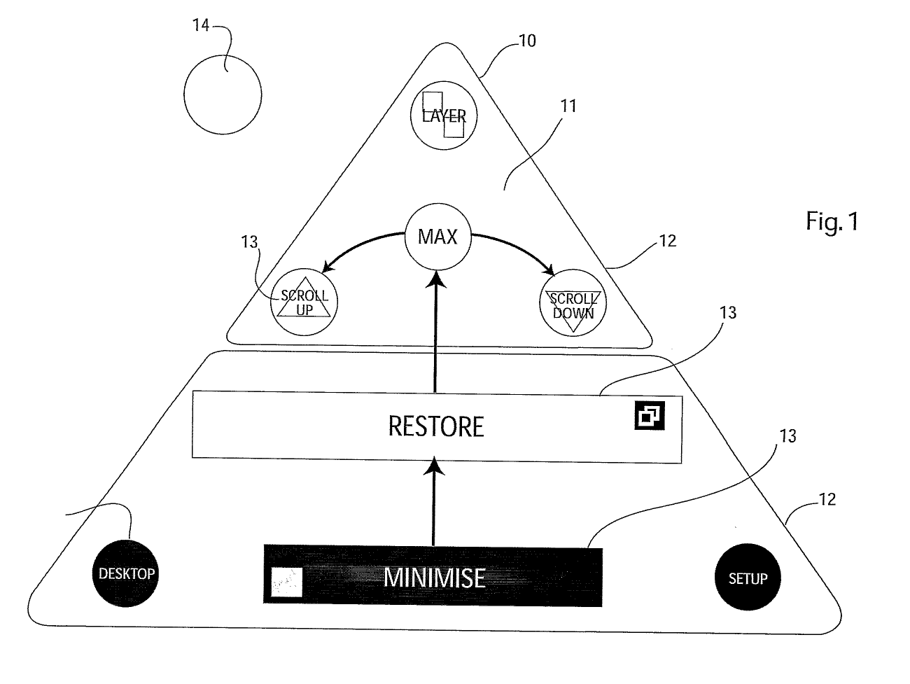

As shown in FIG. 1, the surface 11 of a workspace 10 may be shaped, printed, displayed or textured to define the different regions 12 and/or positions 13 within regions. The interaction between a counter and the workspace may be magnetic or otherwise non-slip or adhesive, or a counter may fit into an appropriately sized recess to prevent counters sliding accidentally. There may be a number of counters that can be placed on the surface of the workspace. A counter fits within a detection range of a sensor that is associated with and generally beneath a region 12 or a position 13, as required.

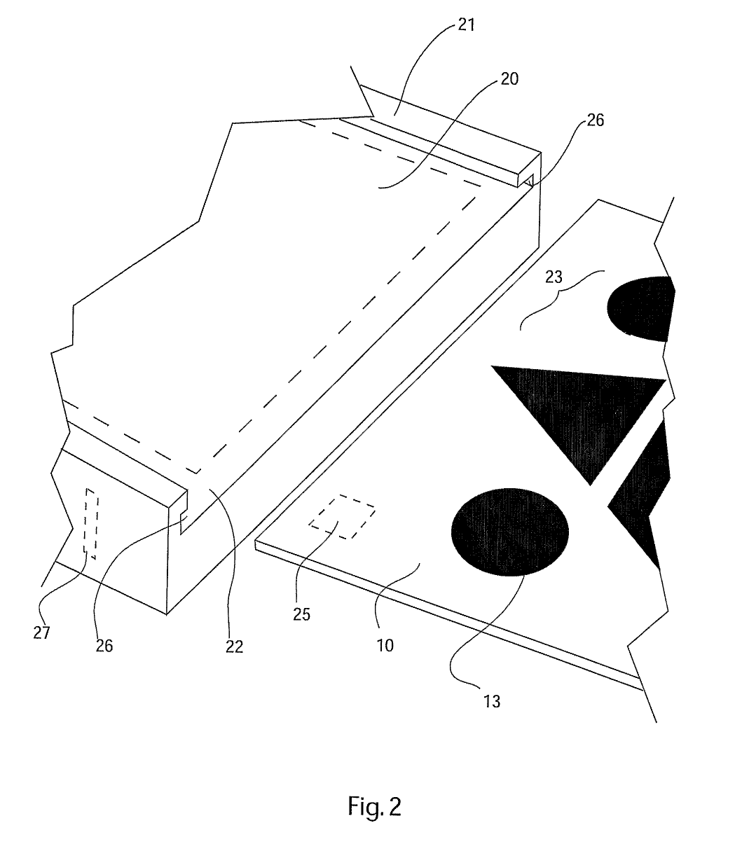

As shown in FIG. 2, an electronic substrate or array 20 of sensors below the upper surface 22 of the interface device 21 consists of a mechanism or array capable of detecting the row and column position or more generally, the location of each of the counters 14. This is an example of a tightly packed array, but the sensor array could equally be widely spaced.

Each counter is uniquely identifiable by the array 20 of sensors, in that each counter can be distinguished from every other counter in the set of counters. For this purpose one can use radio frequency (RFID), magnetic, optical, Hall effect, capacitance or other wireless technologies which provide the required interaction between counter 14 and sensor, for example, a uniquely numbered RFID chip or combination of magnets embedded in each counter. The sensor or array of sensors repeatedly and frequently scan(s) the surface 22 and optionally reports either the changes (eg a re-location of a counter, removal of a counter or placement of a new counter on the work surface) or the positions of all counters. When RFID technology is used, each counter 14 is provided with its own RFID chip or chips and the array 20 contains one or more sensing antennae.

The physical user interface 21 is generally connected to a machine such as a computer, television, set top box, appliance etc., via a data path. The data path may be a USB cable, wireless communication connection, network cable or other uni-directional or bi-directional technology. Except in the case of the control program residing within the physical user interface, or where the physical user interface is wholly integrated into another device or the machine itself, the data path is connected directly or indirectly to a control program that communicates with the conventional electrical circuitry or the operating system or software application programs running on the machine or a second machine in communication with the first machine. In some embodiments a control program is loaded into the operational circuitry of the physical user interface device 21, in which case the data path communicates the output of the control program to the machine or a second machine in communication with the first machine. In other embodiments the physical user interface communicates directly with the machine via internal circuits of the machine.

The physical user interface may be run in series with a USB (or similar) mouse and may have a spare USB (or similar) port for this purpose. It may also be run as a stand-alone interface with an integrated touchpad/trackpoint or other pointing device. It may also be integrated into a keyboard or the enclosure of the machine. Its presence will have no effect on the operation of the mouse or other pointing device.

Control software on the machine or in the physical user interface 21 will allow the user to assign (and to re-assign) to each counter an association with an application or function of the machine (or a second machine in communication with the first machine). For example, a counter might represent a browser, an email client, or a word processing application. The control program communicates with the operating system and/or application programs on the machine (or second machine), transfers any data from the relevant counters on the interface surface and may write to them as well (either directly from its own interface, or as a conduit on behalf of an associated application program or other program or operating system on the machine). In some embodiments, the control program also communicates with the operating system to start and stop application programs, to move windows, to layer open windows and to re-size (including to minimise and maximise) windows.

In some embodiments the control program communicates with an application associated with a counter that the counter has been detected in the workspace, and may optionally also advise and/or store separately the date and time of the detection (the data and time as available from the machine).

A counter may have data storage capacity or memory in the form of flash memory or other read/write (or read-only) technology. The array of sensors may interface with magnetic, infrared, RFID, or other bi-directional signal technology, so that the data in the counter may be read, written, updated, or erased. Thus when a counter with memory is placed on the surface, the region where the counter is located is identified and any data in the counter's memory may be transferred to the connected machine via the data path. Data on any counter may be read, written, updated, or deleted by the control program independently.

Data stored in a counter's memory may be permanent, transient, or ephemeral, or any combination of these. Permanent data may be recorded during or after manufacture, or on first use, and remains without change. Transient data may be read, written, updated, or deleted, for example, by an associated application program. Ephemeral data is deleted once read. A counter used in any embodiment of the invention may have a combination of these. For example, the identity of the associated application may be permanent data so that the counter is always used with and identifies the same program. User preferences may be transient data so that they remain constant until changed by the user. Temporary application state or status data may be ephemeral.

In one embodiment, when a new counter (previously unused) is placed in a workspace, the control software set-up interface may launch automatically and prompt the user to associate the new counter with an application. In an alternative embodiment, the placement of a counter within an appropriately designated region in the workspace will launch the software setup interface and prompt the user to associate the counter with an application.

In another embodiment, when a new counter (previously unused but with stored data) is placed on a region, the control software may launch an associated application automatically (if not already running) or may prompt the user to associate the counter with a default or selected application based on the counter's stored data in the counter's memory. Any related data on the counter could then be read and transferred to or used with the associated or selected application.

Once a counter is associated with an application, the consequence of a new instance of use on the workspace 10 is initially like a mouse click on a desktop icon in that it may launch the associated application. However, once an application is launched, previously recorded application data on the counter (or data stored on the machine but associated with that counter) may be transferred to the application without user interaction, may be transferred to a different machine (such as a web server) which in turn may send data to the application associated with the counter, may generate alternative interfaces to the application or may allow a user to record data to the associated application with or without displaying the application itself.

In one embodiment, when a counter is removed from the surface (either lifted off completely or slid to a non-active zone outside the matrix of regions) and has not been replaced within a designated time, the associated application may close automatically (or at least commence a close routine). While the counter is located on the surface, the application may update data on the counter according to the design of the application and the interactions with the user. Transient data may be updated and ephemeral data erased once read. As the counter may be moved or removed by the user at any time, the application is designed so that transient data is updated in a timely manner.

In another implementation buffer zones may be provided around active regions on the surface whereby if a counter is accidentally knocked and moves into a non-active zone (but within the detection range of the sensor array), the software will not alter the window state of the associated application.

In yet another embodiment, removing a counter from the workspace minimises the associated application window. In a further embodiment, removing a counter from the workspace does not alter in any way the last state of the associated application.

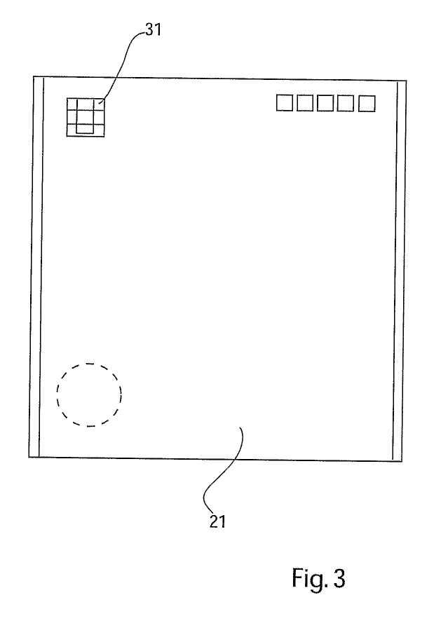

As shown in FIG. 2, the façade of a workspace 10 may be interchangeable with other appropriately adapted facades 10. In the embodiment of FIG. 2 the facade 10 is depicted as a thin matrix onto which is printed a triangular symbolic legend or map subdivided into regions and positions 13 as described above. With respect to FIG. 2 the facade may carry a graphic map or legend 23 that corresponds to a particular use, application or machine. As shown a facade 10 can also carry an identifier 25 that can be read by the interface device 21. The identifier may be a microchip having a memory and external contacts, another RFID chip, an optical device such as a barcode, a tactile mechanical feature or an opening whose size or location is detectable by the interface device 21. In this way a facade 10 can be identified by the physical user interface device 10 or by the associated machine in such a way that the functionality of the physical user interface 10 or its sensor array is altered to suit the use and the specific map 23 selected by a user. In the example of FIG. 2, the facade 10 slides between a pair of opposed slots 26 that run along the side edges of the interface 21. As shown in FIG. 3, the interface device 21 has a reader 31 that can obtain identification information or facade data from the identifier 25. Each optional facade is individually identifiable (for example, by way of an embedded RFID chip). When the physical user interface device 21 detects a new facade it sends an output signal containing the identity of the new surface to the machine to which it is attached or with which it communicates, and software running on the computer can either download new control program code from the facade (stored in memory in the surface or in the RFID chip) or it can run new control program code previously loaded on the computer by the user; or, if it has not done so previously, it may download the new control program code from a storage device or from another machine designated by data downloaded from the new surface, and run that code. The software may download or run the new control program code either automatically, or as a result of a command by the user, for example, when the user accepts a prompt to change the regions on the workspace.

The new control program code downloaded from the new facade, or run from the computer may replace all or any part of the original control program—such that the recognition of the location and orientation of counters in the regions and the actions taken as a result of the placing, moving, removing or re-orienting of counters may be altered in total or in any part.

In further preferred implementations the map or legend 23 of the workspace 10 may be altered by some action of the user on the device (such as turning a switch or performing some other action directly on the workspace) or by software running on the machine to which the device is connected, or with which it communicates. The triggering of an alteration of the workspace by software may be at the command of the user (making an explicit command via some software specifically designed to allow the user to choose between two or more workspace shapes), or automatic, as a result of some other action by the user (such as launching an application, placing a particular counter in the workspace). This can be done where the map or legend is depicted on a graphical display device that resides above the sensor array 20 and that serves as a workspace 10. Another example of the alteration of the workspace by specific command of the user is the instance of a two dimensional workspace with a different facade on each side and a means (such as a gravity switch) of determining which surface is up. The physical user interface device sends, in addition to data regarding the position and orientation of counters in its workspace, data regarding its own orientation. Façade data related to the orientation of the physical user interface device may, in this case, be stored within the physical user interface device, within a removable façade, on the machine or on a second machine in communication with the first machine (in which last case the data may be downloaded and stored for use on the first machine or may be run on the second machine).

In another implementation, the regions 12 or positions 13 within a workspace can be changed. The change of regions could be effected, in the case of a workspace consisting of an electronic display screen, by changes to the visual display. Such a change could be at the command of the user (either directly on the device by, for example, turning a switch, or by using software running on the machine to which the device is attached or with which it communicates), or it could be automatic, as a result of some other action by the user (such as launching an application). A change of regions may also be effected by the user replacing the facade of the workspace 10 with a new surface displaying a different layout, for example, by sliding one surface out and replacing it with a new surface as shown in FIG. 2. The change of regions may occur with or without any change to the shape of the workspace or the shape of the area scanned by the sensor(s).

So, for example, a facade 10 could be placed on a physical user interface device and it would be recognised, then, if required, new control program code would be run in response to status data received from the physical user interface device and, optionally, façade data related to the active facade. Optionally new counters 14 may be called for and used—and the workspace could become a custom game controller or even a mouse or pointing device.

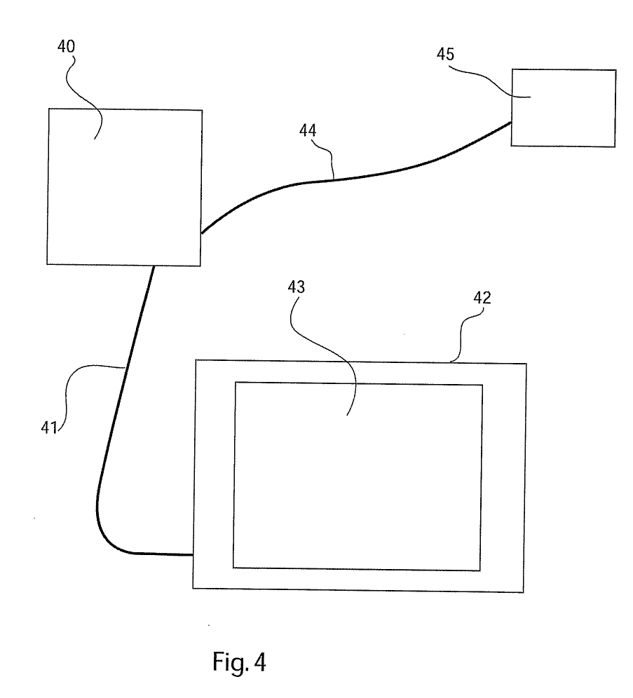

In some embodiments, and as shown in FIG. 4, an interface 40 is packaged in an enclosure with the hardware capabilities to enable it to generate its own static or dynamic display independent of an “outboard” PC or processor. This is done by connecting a wired or wireless output 41 of the interface, to a device 42 such as a television that has a display 43. In this way a second output 44 of the interface 40 can be used to drive or send command signals or command strings etc. to a machine 45 that, within view of the physical user interface, has no display or an inadequate display.

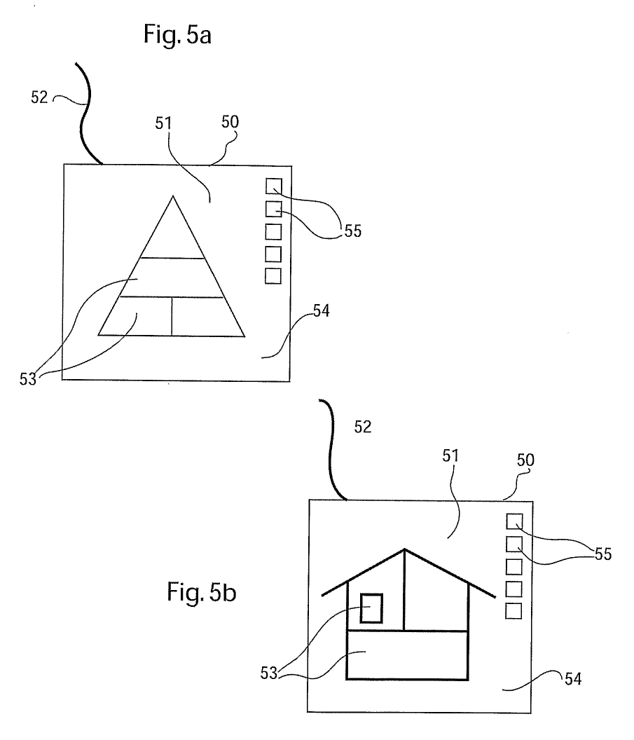

As shown in FIG. 5, the interface 50 can receive configuration commands from a device or a user that can act to re-configure the workspace's appearance 51 and functionality. The interface can receive configuration commands in a number of ways. In one embodiment, the commands are sent via a bi-directional wired or wireless connection 52 between the physical user interface device 50 and the machine. The configuration commands can be generated automatically by the machine or by user interaction with the machine. A configuration command can have the effect of causing the workspace to change appearance 51 such that new functional regions 53 are displayed by the interface even though the location of the sensors remains the same. This may be accomplished by using a touchscreen or electronic paper display 54. A touchscreen can act as both display surface and (touch) sensor array. Where electronic paper is used, the sensor array (such as an RFID antenna array) can be located below the surface of the electronic paper. Using either of these technologies or their equivalents, the way the interface looks and the distribution of regions can also be changed by providing control regions 55 that react to counters or user operated buttons 55 located on the interface. Placing a counter in a control region 55 or pressing a virtual or actual user button 55 can thus change the appearance and functionality of the interface's display.

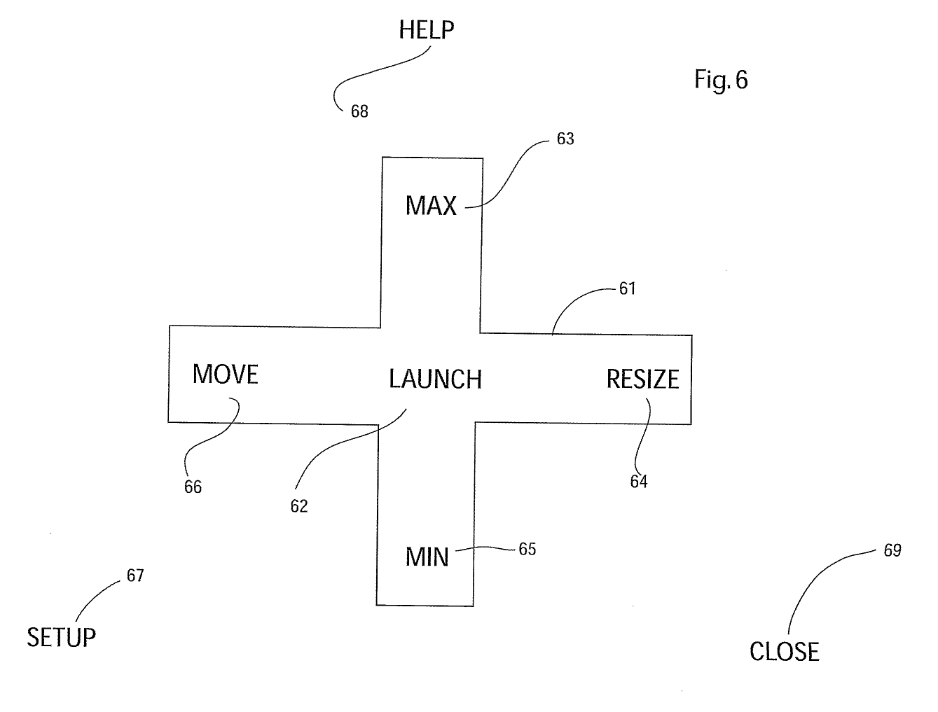

Another particular workspace facade layout is disclosed in FIG. 6. As shown, the primary control area 61 is cross shaped and includes a central application “launch” region, and arms 63-66 corresponding to application window maximise 63 (or MAX), application window resize 64, application window minimize (or MIN) 65 and application window move 66. Each region is associated with an antenna. A triangular array of other regions corresponds to commands that retrieve on-screen help 68, that close an application 69 and that run a setup routine that may be particular to either the interface or the application that is currently being run. In this embodiment it is contemplated that if one were to remove a counter from the workspace (accidentally or not) nothing happens. The control program only reacts to the placement of a counter within a region and not removal from a region. Thus commands like open, close, minimise, etc are all positive actions, and can generally not be executed by the control program as a result of user accident or carelessness.

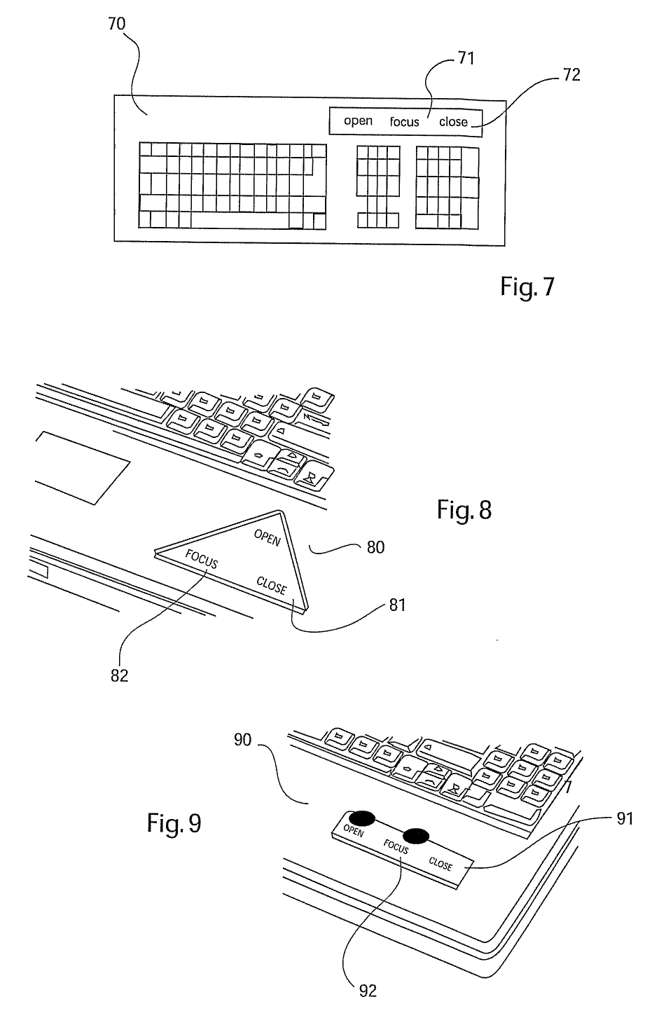

As shown in FIG. 7, an otherwise conventional interface device such as a keyboard 70, joystick, touchpad/trackpoint or mouse can incorporate a workspace 71 that can perform like the other workspaces disclosed herein. In this example, the number of zones and hence the number of commands 72 is reduced to three. In preferred embodiments, the workspace is located on the top surface of the device 70.

As shown in FIGS. 8 and 9, devices such as laptop computers 80, 90 can incorporate a workspace 81, 91. As shown, an otherwise unused portion of the upper surface of the body is used to locate the workspace, with the sensors located beneath. In these examples, the workspaces are provided with three zones 82, 92. In one example the zones 82 and sensors are located in a triangular array with the “open” command located at the apex of the triangle. In the other example, the zones 92 are located in a line.

### Software Examples

The interface of the present invention is proposed for use on PC type devices as well as a range of other machines that are not PCs but that do have an operating system that can be controlled or commanded. What follows is an explanation of the software components that would typically be installed onto a PC. These teachings are considered applicable to non-PC machines, by analogy.

There are five main software components in the typical control program. Items 1-4 are installed onto a PC or otherwise provided in analogous machines:
1. The Device Driver: The device driver establishes a bi-directional communications channel between a machine and a remote physical user interface device, on top of a physical transport layer such as USB or Wi-Fi.
2. The Central Data Unit: The central data unit (“CDU”) communicates with the physical user interface on a single or bi-directional channel established by the device driver. It communicates with the counters on the workspace and it also receives data from the workspace. Data received from counters is retained in a first array of elements, each array element containing counter ID information, specific hardware supported counter state information and data stored on a counter. Data received from the workspace (state information) is maintained in a separate second array, and includes the hardware, connectivity, orientation, version, model and information about, associated with or stored physically on the current workspace. The CDU also defines mechanisms to enable error safe transfer of data to and from counters on the workspace including support for an automated resume function in the event of a failed or interrupted transfer.
3. Routing Module: The routing module (“RM”) passes data received from the hardware to the Application Control Interface (see below). If there is more than one Application Control Interface, the RM determines, based on data received from the hardware or under explicit instruction from the user, the correct Application Control Interface to receive the data. If the correct Application Control Interface software is not running, it is launched and the connection established. If the correct Application Control Module is not available when required, the Routing module may trigger a download from another location, such as a web site or a removable storage medium. This may occur with or without user intervention. The Routing Module may also, on receipt of appropriate data from the physical user interface hardware (one or both of the workspace and counter(s) on the workspace)—such as a change in counter orientation or workspace orientation or type, or data uploaded from a counter—automatically update one or more Application Control Interfaces or break the connection with one Application Control Unit and create a new connection with another different or updated Application Control Unit.
4. Application Control Interface: An Application Control Interface translates data received from counters into user-defined commands to the operating system of the machine and/or to applications running on the machine (or a second machine in communication with the first machine). The available commands are contained in a table or library of pre-defined functions and events that can be used by an application to define behavior based on hardware and user input events. End users or developers are free to create additional functions and events in addition to those supplied.

### Provided Events are:

Counter first seen
Counter removed
Counter re-oriented
Counter moved
Counter orientation changed

### A Special Event is Reserved for:

workspace changed
   Supported Functions are;
Open Application Window
Close Application Window
Maximise Application Window
Minimise Application Window
Move Application Window
Resize Application Window
Setup Counter
Show Desktop
Read Counter Data
Scroll Application Window
Write; receive and process data received from counters and the workspace; and formats data to be sent to counters on the workspace.

Developers or users may define their own layout of active cells in the antenna array in order to customize the workspace to suit a particular class of user or type of application. A tool is provided that allows the user to use a program to “paint” functions and configure events onto a graphical representation of the physical user interface device's cell array. The graphical representation may be printed out and used or implemented on a workspace that has graphic display capabilities. Design rules encoded with the program prevent the tool from making layouts that are useless. In one example, the saving of the user defined configuration then triggers the compilation of a new Application Control Interface based on the used events and functions. Optionally that Application Control Interface can be installed without further prompting.

Via the data link between the machine and the physical user interface device, an Application Control Interface may request data to be written to a counter. The Application Control Interface is responsible for ensuring data is of the correct size and format for storage on a counter.
5. User Control Interfaces: User Control Interfaces (“UCI”) provide graphical presentations allowing users to update an Application Control Interface; to process data received from counters; and to input data to be transferred to counters on the workspace or to be stored associated with the counter or by the application associated with the counter. The UCI may also provide additional interfaces that do not relate in any way to the actions of the Application Control Interface.

Examples of Use of the Interface

A number of alternative embodiments are contemplated. In one family of embodiments the types of interface devices described above are combined with either solid state or hard drive type mass storage. In one such embodiment portions of the storage capacity may be linked with individual counters such that data can only be written to or read from that portion of the storage when the associated counter is present on the workspace.

In another family of embodiments, the sensor cell or cells and components associated with the stand alone interfaces disclosed above are embedded in some other device such as a keyboard, product enclosure, remote control, game controller or mouse.

In yet another family of embodiments the data link between the physical user interface device is a network such as a LAN or even the Internet. A microprocessor such as the Freescale MC9S12NE64 with an in-built Ethernet interface can operate the physical user interface device (in accordance with the other embodiments described herein) and can also address its output data stream to one or more machines on a LAN or accessible from the LAN. To enable the user to know that commands issued from the physical user interface device have been received by the target machine (and also to receive any feedback or other data from the target machine) the physical user interface device may also have a local display screen (CRT, LCD, LED, plasma, etc.) and/or audio output, a simple feed back mechanism (audio, video or a blinking LED), or it may have no feedback/display capacity at all. Content displayed/presented on the display device/audio device may come from the interface device or the remote microprocessor. In a further improvement on this embodiment the target machine for output data from the physical user interface device may be identified by data contained in one or more counters on the workspace. Different counters may identify different machines, and data relating to each counter's position, and orientation and any data downloaded from such counters will be routed to the designated target machine. It is possible therefore by this method to have one physical user interface device send data to more than one machine at a time.

A surface layout can be supplied by the factory, acquired from a third party or created by the user. Each layout will use some variation of the basic control program (i.e. a different ACI). Layouts may be changed in one of three ways—turning the device over; physically removing one and replacing it with the other; or changing some display system on the surface of the device (LCD, electronic display, laser projection, etc.) When a display is changed there will be either an automatic or user-initiated change of the control program to accommodate the different ‘active’ cells and functions attached thereto (including, e.g. removal of counters). The software required to update the control program can come from one of 4 sources—the surface itself, a download site identified by the surface or a counter on it, the memory of the machine (i.e. pre-loaded but not active), or a removable storage device (e.g. CD ROM). Whatever the surface or the ACI associated with it, the output from the device to the machine is the same—a string of data containing cell information-counter present, counter ID, counter data, etc. The ACI interprets and translates this into commands meaningful to the machine and corresponding to what the user expects based on the legend on the surface.

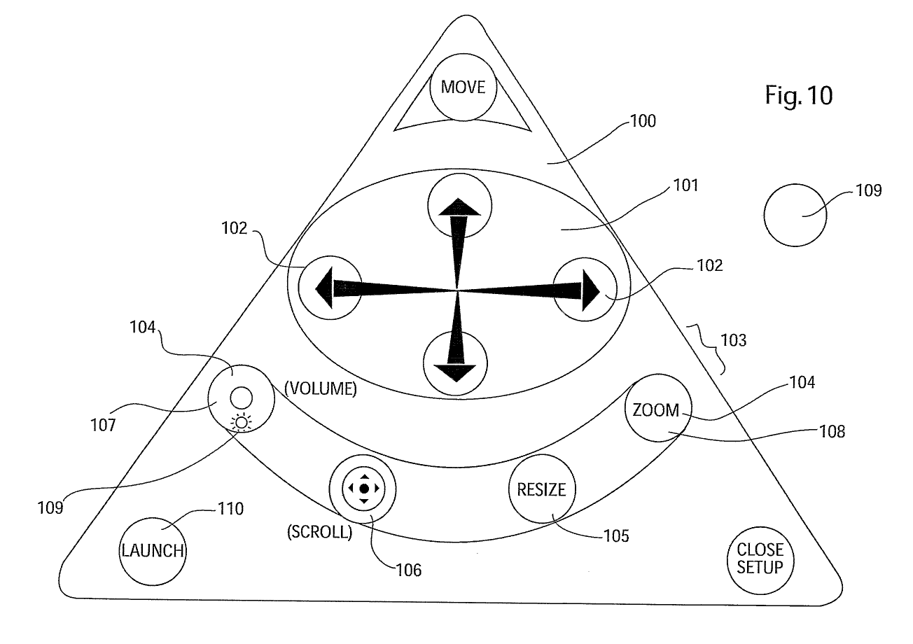

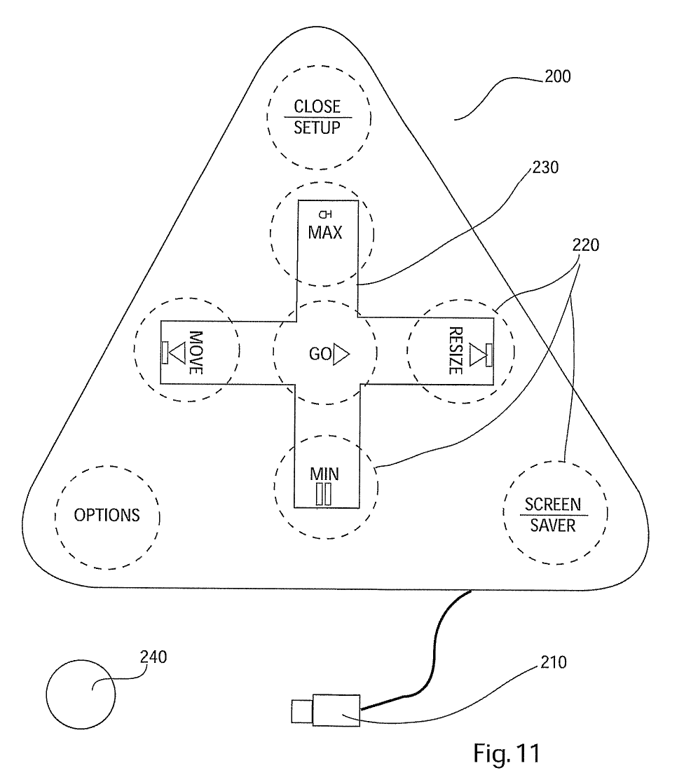

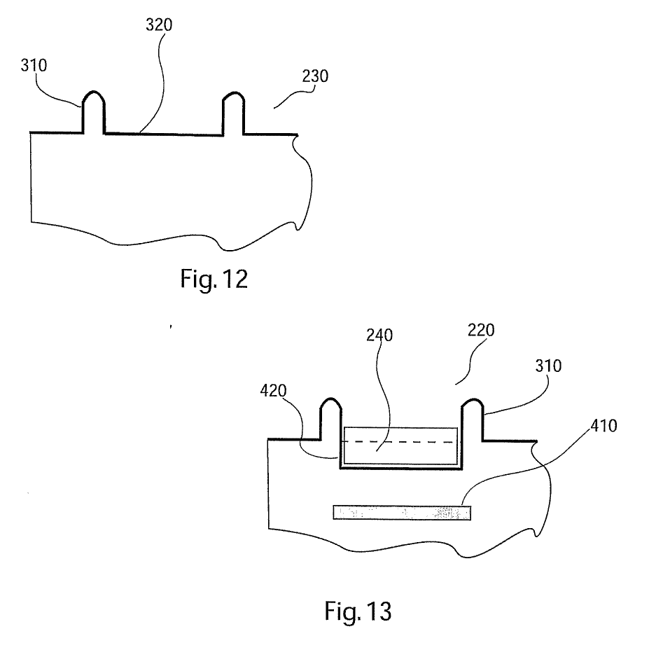

In order to provide a useful control of a machine (such as a personal computer), and with reference to FIG. 10, the following further example implemented in conjunction with an RFID interface of they types disclosed above.

The surface or workspace 100 of the device has one region designated as a ‘control panel’ 101, consisting of 4 or 5 active zones 102. In the case of 4 zones, one zone corresponds to each of ‘up’, ‘down’, ‘left’ and ‘right’. If a fifth zone is used, it may be designated ‘stop’.

A further number of zones 104 are designated as ‘mode selectors’ 103. When a counter such as an RFID counter (not shown) is detected on a mode selector zone 103 and is then moved on to the control panel 101, the counter will carry the last or selected mode into the control panel.

Examples of the available modes are ‘re-size’ 105, ‘move’, ‘scroll’ 106, ‘volume control’ 107, ‘zoom’ 108 and ‘arrow keys’. A sample operation would be as follows:

A counter is placed on, say, the scroll mode zone 106. For a designated period of time that mode will remain active, and if during this time the counter is then moved on to the control panel 101, the content in the window for the application associated with that counter can be scrolled up, down, left and/or right by the counter being placed on the appropriate arrow (e.g. 102). Once the counter is removed from the arrow (or returned to the ‘stop’ zone if there is one), the motion or other action will cease, and after a designated time, if the counter has not been detected again in the control panel 101, the mode will revert to a default action of the control panel.

By this means, the same control panel can achieve many functions, including but not limited to scrolling, increasing/decreasing audio, re-sizing windows, moving windows, zooming the text in windows, assuming the function of the computer's arrow keys, etc.

In some implementations of the device, while a mode is active there will visual feedback to the user. This may take the form of a LED 19 embedded in the mode's zone, for example, under a translucent surface within the zone.

Similarly, in one implementation of the device, when a mode is selected by the user placing a counter on the mode zone, there will be feedback in the form of either a LED or an audio signal (from the device or from the machine to which the device is attached).

The control panel may be given a default mode that will operate if a counter is placed in the control panel region without first having been detected in a mode zone.

A counter 109 such as an RFID counter placed on the device 100 may contain downloadable data in its memory space. In order to keep the cost of counters to a minimum, the memory capacity may be very limited. One of the practical uses of the memory space is to have counters pre-loaded prior to being acquired by the user. A simple and useful form of data is a URL for a web site or a simple, comparatively short text string. A counter 109 pre-loaded with URL data, will, when placed on a selected zone 110 on the surface of the device, launch the user's browser, navigate the browser to the URL stored in the counter's memory and take control of the window.

Some URLs are very long. In order to preserve the memory capacity in a counter for other uses, the URLs can be optimised so that they reference a URL in an intermediate site that stores the full URL and re-directs the browser to the desired web site. For example, a long URL may be stored on a re-direction website associated (by some action of the owner of the re-direction website, with or without a fee attached) with a short URL. The short URL is pre-loaded on the counter. When the pre-loaded counter is placed on the surface and detected by the sensor array, the user's browser is launched and it navigates to the re-direction website. The re-direction website recognises the requested URL and re-directs the browser to the associated long URL.

In addition to optimising the URL for efficient storage on a counter, the re-direction website can audit ‘click throughs’—instances of a counter being used to access a pre-loaded website. In one implementation of this method, the owner of the re-direction website can charge a fee based on click through traffic. Data carried by the counter may optionally be used or collected by any URL that is directly or indirectly requested.

In one implementation the software controlling the interface device stores a URL and on receipt of data stored on a counter, transfers that data to the stored URL (and concurrently launches a browser application). The web server at the stored URL is in communication with a database and checks the data retrieved from the counter against records in the database in order to determine what action is to be taken (such as directing the browser to a further URL).

In one implementation, the short form URLs will be in a format prescribed by the supplier of the device, and no other URLs will be recognised.

In a further implementation the URL pre-loaded in a counter may be associated, on the re-direction website, not with another URL, but with a source of downloadable data stored on the re-direction website server or some other server in communication with the re-direction website server. On receipt of a request from the user's computer for access to the data indicated by the short form URL, the re-direction website server may directly or indirectly distribute to the user download a wide variety of data in a format or formats other than that usable by the user's browser. Data broadly includes conventional data and by way of example and not limitation, files, streams, executables, archives or applications.

In this way the counter acts as a key to online data sources and does not itself need to store significant volumes of data.

Another embodiment of the invention is now disclosed with reference to FIG. 2. This embodiment provides means of facilitating accessibility and enhancing productivity. In particular this embodiment provides enhanced means of access to and control over selected locally or remotely stored digital content (in both file and stream format).

The embodiment depicted in FIG. 2 retains the triangle layout of RFID cells or zones 220 discussed with reference to FIG. 1, but the number of active cells 220 within the triangular array has been reduced to 8. Each active cell or zone is associated with an RFID antenna located below the surface of the device (see 410, FIG. 4). This simplifies the device and reduces manufacturing costs. In fact, any number of active cells can be accommodated without departing from the broad design concept. The device 200 is powered by the USB connection 210. It reads ISO compliant RFID tags 240 that may be embedded in counters, counters, toys etc.

The software that cooperates with the device 200 is modular. A core application controls the communication between the computer to which it is connected and the device 200. All functions of the computer resulting from the placement and movement of counters 240 on the hardware are controlled by plug-ins and can be changed easily without replacing the whole application.

The active cells 220 and the various paths between the 5 cells in the central cross 230 are defined by textures in the layout surface—such that a counter has a ‘positive’ lock in the correct position (ensures good RFID communication); and a guided path between relevant cells (enabling movement of the counters without the user having to look at the board). As shown in FIG. 3, raised side walls 310 can be used to define a path 320 in which the movement of the counter 240 is restrained. As shown in FIG. 4, the area directly above an active cell's antenna 410 can be in the form of a depression 420 slightly larger than the counter 240. When the counter 240 is in the depression 420, it is mechanically stable and in good radio contact with the antenna 410.

There are three suggested modes of operation: computer mode, media mode and games mode.

In computer mode, counters 240 can be identified and assigned to any PC application and re-assigned at any time. Counters may be embedded in any suitable container such as suitably shaped and sized toys. Primary counter functions in this mode are: launching applications; restoring, maximising, minimising, re-sizing and moving application windows; and closing applications.

In one implementation, the ‘MOVE’ and ‘RESIZE’ functions, activated when an appropriate counter is located or the corresponding active cell 220, use the computer's mouse during which time the cursor is automatically anchored to the appropriate area on a GUI window so that the user need only move the mouse (without clicking or holding down a mouse button) to move or resize the window. When the counter is removed, the cursor is released. In a further implementation the ‘MOVE’ and ‘RESIZE’ functions operate without any reference to the mouse, re-locating and/or re-sizing the application window automatically (through a designated series of steps), either in response to the repeated detection of a counter (eg the user tapping the counter on the cell) or in response to the counter remaining on the relevant cell for more than a defined period.

An application can be launched (or restored if already running minimised) by placing its associated counter on the central ‘GO’ cell shown in FIG. 2. For convenience, an application can also be launched or restored by placing its counter on either of the ‘MOVE’ or ‘RESIZE’ cells in the cross area 230. In the latter cases (where a window is restored by a counter being placed on either of the ‘MOVE’ or ‘RESIZE’ cells) the additional function will be immediately available on launch of the application—i.e., as soon as the window is displayed, moving the mouse will re-locate or resize the window. When a window is launched by a counter being placed on the ‘GO’ cell, the curser is centred in the application window.

When a counter is removed from an active cell, its associated application stays in the last state it was in (so once a desired action has been performed, the counter can be removed from the board). If, having restored an application window, a counter is left on the board on the ‘GO’ cell, the cursor will be ‘locked’ within the window (so that it cannot be moved beyond the borders of the window). As soon as the counter is removed, the curser will be free to move anywhere on the desktop.

One counter can be assigned (via placement on the ‘SETUP’ active cell 220) as a ‘Temporary Controller’. A counter so assigned can take control of any window having focus by placing it on the ‘GO’ cell. It can release its application and also launch and control any one of a number of utility applications (eg calculator, Notepad, Windows Explorer) from a list displayed when the counter is placed on the ‘OPTIONS’ cell 220. The last assignment of a Temporary Controller is not retained between sessions (or after the Temporary Controller has been used to close its associated application).

In the Media Mode, any counter can be assigned to a custom ‘Media Controller’ supplied with the board. A Media Control counter controls the following functions: launching online streaming radio or TV channels; changing online streaming radio or television channels; playback of local or remote stored audio and/or video play lists; step advance/rewind/pause of local and/or remote stored audio or video play list; muting of any audio/video presentation and disconnection of a service. When the Media Control counter is placed on the ‘GO’ active cell, the last played audio or video service recommences. When the counter is placed on the Channel cell (the MAX cell but also marked ‘CH’) the full list of locally available channels (media bookmarks) is displayed. Using the keyboard arrows the user can move a highlight in the Channel List to a new channel in the list. When the counter is returned to the ‘GO’ active cell (or when the user presses ‘enter’ on the keyboard) the current channel shuts down and the newly selected channel launches. During loading (and for a short while after connecting to a channel), a ‘station ID’ is displayed, identifying the channel and providing status information (eg buffering, connected, etc.). The Media Control counter also displays connection time and (for play list items) track time as well as track titles. The Media Control counter will be displayed again if the media counter is placed on ‘GO’ or either of the ‘LEFT’ and ‘RIGHT’ arrows. The ‘LEFT’ and ‘RIGHT’ arrows allow the user to step forwards and backwards through the files in a play list. This last function is not available for streaming services. If the media counter is placed on the ‘MIN’ cell (also marked ‘PAUSE’ in text or symbolically) playback will be paused until the counter is removed (if the channel is a live streaming channel, only the audio will be muted until the counter is removed). The ‘OPTIONS’ cell allows the user a) to save media bookmarks to the local Channel List; b) to download play lists (including the media files); and c) to create and to manage local play lists from files stored on the user's computer. Play lists may be audio, video or mixed. An integrated download manager handles the downloading and installing of media files.

In Games Mode, any counter can be assigned to a custom ‘Game Controller’ supplied with the board. A limited range of games can be played by moving the counter over the 4 arrow cells and using the keyboard's Enter key or Space Bar. The game is selected from the ‘OPTIONS’ active cell. The ‘GO’ cell is not active in game mode.

In one implementation, the software running on the PC associated with the interface device may store in memory the last state of applications controlled by the device prior to the machine being turned off. Then, when a device is next powered up, it may provide the user with the option of restoring the associated applications without having to place their associated counters on the workspace.

The above descriptions are demonstrative of the current implementation and represent the best set of features from which an initial consumer product may be constructed. By simple update of the relevant plug-in, a different set of commands based on counter detection and location can be installed (such as routing the output of the PC to an external device like a TV set so that the PC becomes an internet tuner/receiver for IP audio and video services).

Note that the functions attached to the various active cells may vary depending on the assignment of the counter. For example, the Media Counter discussed above, created by assigning a standard counter to ‘media’ in the setup process has a different range of functions to, say, a browser or word processing counter. The Media Counter doesn't use a mode cell in order to get the alternative range of functions—it is recognised by the software as a Media Counter and automatically a different set of functions is applied. This is enabled by the modular software design set out above.

Silo is used to refer to an enhanced ‘Favourites’ or ‘Bookmarks’ application. It can operate as a stand alone application or as a toolbar extension for any web browser. The primary function is to allow a user to create a list of required websites which are downloaded and stored on a user defined schedule—so ensuring that the most recent version of each site is cached locally and that each site will load when required (whether the PC is online or offline at the time) with the minimum possible delay. The Applicants Australian granted complete patent specification 2003200819, entitled: “Browser Plug-Ins” is incorporated by reference. A counter may be assigned to the provided ‘Silo’ application. The Silo counter allows the user to launch a customised browser and to navigate the list of bookmarks like a media play list (stepping forward or backward through the list).

A counter may be assigned to the provided logging application. Placing the designated or assigned logger counter on the board will store the date and time the counter was detected and will optionally allow the user to enter some brief text annotation for the log entry. The log builds over time (with each occasion on which the logger counter is detected) and can be saved in a variety of formats and/or forwarded to a remote computer. Several logs may be kept concurrently, with each entry being assignable by the user to any one of one or more user-created logs.

The board interacts with external data in two ways: with on counter storage and with online data. With “on counter storage” the counter ID or ancillary data storage space on the counter may be encoded so as to be separately significant to the board (beyond simply providing the counter with a unique identity). The current implementation of this feature works as follows: significant data (in a prescribed format) is read from the counter and triggers a) the launch of a browser; b) the direction of that browser to a system-defined URL; c) the transfer to that URL of data related to the on counter data; and d) the re-direction by the server at the first URL to a second URL (website or file), based on the content of the transferred data. The web server at the first URL logs the time of the re-direction, the IP address of the user's PC and the destination of the re-direction.

With the “Online Data” feature, a Media Controller counter, when placed on the ‘OPTIONS’ cell, will establish a connection to an online list of radio and television channels, online play lists and/or downloadable media. Channels and online play lists selected by a user are stored locally in the form of ‘Media Bookmarks’ in a browser. The Media Bookmarks may include both streaming channels and aggregated play lists (of video clips/songs, etc.). Each online, aggregated play list is stored at a static URL, but the files/URLs stored in the play list may change at any time.

The user can download entire play lists (including media files) and/or create local play lists of audio and video clips. These will appear in the ‘Media Bookmarks’ listing and can be launched/controlled in the same manner as the remote lists. A similar ‘download’ service can be provided for games and/or other applications that could be used with the hardware.

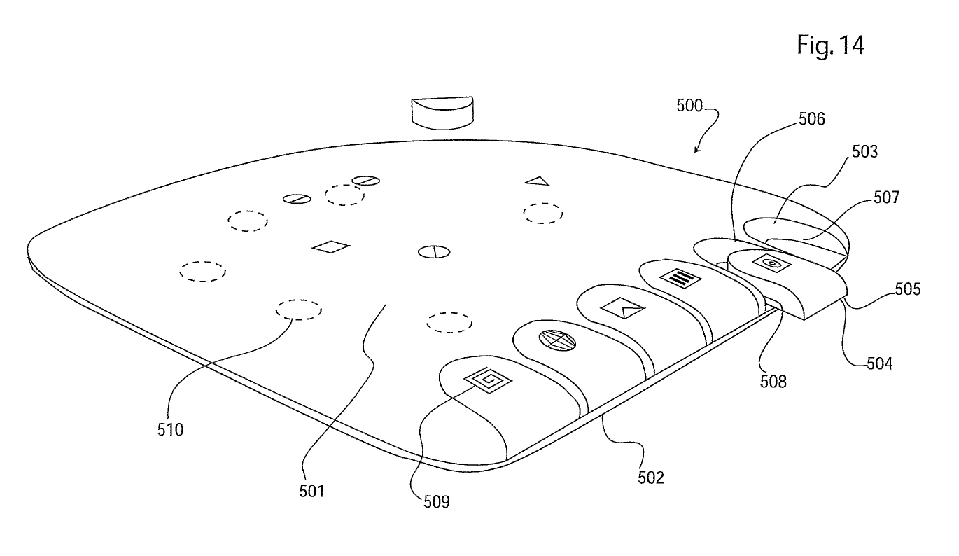

A further embodiment of a housing and counter style is depicted in FIG. 14. In this example, the physical housing 500 has the user accessible functions arranged in regions in a circular array 501. The antenna or sensors 510 for the various regions are also provided in a circular array in locations corresponding to the regions on the workspace, but below the workspace. One edge 502 of the device is formed with a succession of spaced apart scalloped recesses 503 adapted to receive and store the counters 504. The counters 504 have a radiused edge 505 that blends into the edge 502 of the housing and a “U” shaped perimeter that fits within the scallops 503. The side walls of each scallop 503 have longitudinal ribs 507 that cooperate with longitudinal slots 508 formed into the parallel side portions of the perimeter 506. Thus, the counters 504 can be stored, flush with the workspace, in the scalloped recesses until they are used. As illustrated, the counters may be imprinted with a graphic message 509 that represents, for example, a symbol designating a programme or programme type (email, browser, word processor etc.) or a logo or trade mark or other promotional message. Such counters may be provided under license by third parties in conjunction with various promotional methods.

As shown in FIG. 15, a counter 600 can be provided with a perforated post 601 and ring 602 so that it may be used as an ornament, accessory or key ring.

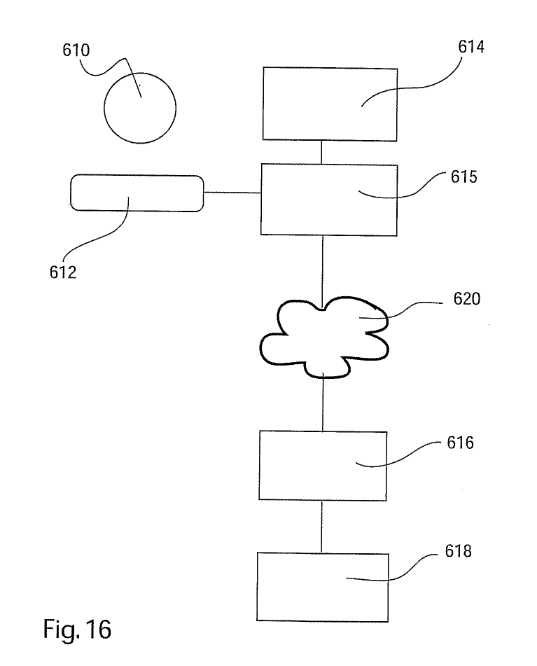

As shown in FIG. 16, ancillary data stored on the counter 610 can be stored in multiple ways. For example, it may be a specific number range (different from standard tag identification) or it may be contained in a specific data block (for example blocks 4 to 6). Ancillary data collected by reading the counter 610 with an interface 612 may be in any number of forms—for example, numeric, text, binary and files. The form of the ancillary data may act as the trigger for different events in the software controlling the interface device. Ancillary data of one form (say, numeric) may result in a web browser being launched, for example, on a display 614 associated with a user's machine 615. The browser is then navigated over a network 620 to a first URL that runs a script on a remote web server 616 (via a HTTP POST operation). The POST data could contain any number of user details in addition to the ancillary data. The server script extracts the ancillary data from the POST data and references it against a database table that contains redirection information. The script may then redirect the user's browser to a second URL 618 (local or remote to itself) as well as recording details (such as date, time and requesting IP address) to the database. The second or any subsequent URL is considered indirectly indicated by the counter's ancillary data.

Redirection URLs can contain web pages, files or scripts. If the redirection is to a script, the redirection will be formulated into a HTTP POST request containing the data defined in the redirection table of the database. The end script could then perform any actions it needs on the data including but not limited to: recording it in a database, referencing the data against a database, and providing a personalised web experience. The redirection and scripts executed are masked from the user.

In another case, ancillary data to be used in local applications (on the machine 615 with which the interface device is associated) could be stored in another way. As data intended to be used by local applications is far more likely to contain non-numerical data, it may be reserved to a certain range of data blocks on the RFID tag 610. For example a local application ID may be stored in data block 7 with data intended for use by that application stored in blocks 8 to 20. Data (in numeric, string or binary format) would be passed directly through to the target local application. This system need not send a HTTP POST to a web server, but there is no limitation on doing so.

For example a person storing ancillary data to a tag 610 may store the name and date of birth of a user on a loyalty card (containing a suitable tag) in data blocks 8 through 20 with an application ID in block 7 (referencing an application previously stored on the user's machine). The control program on the user's machine 615 launches the local application referenced in block 7 and routes to it the data from blocks 8 through 20. The referenced local application, for example, then might present the user with a personal welcome message, a loyalty points tally and birthday message should it be the user's birthday.

A database is employed in association with the re-direction web server 616 to store redirection locations e.g. 618, advertising; event information (including but not limited to time and date, IP address of user, ancillary data and serial number of the interface device which read the ancillary data); and billing information. The database utilises multiple tables to organise the data. Web scripts are used to interface with the data stored in the database and to record additional data as required.

What is claimed is:

1. A method for distributing data, comprising the steps of:
providing stored information on a physical counter of a kind that can be interpreted by a physical user interface connected to a user's machine, the interface adapted to indicate a location of the counter as well as retrieve the stored information;
the information being directly or indirectly indicative of a URL;
distributing from that URL, data to the user's machine as a result of the user using the counter with the interface.

2. The method of claim 1, wherein:
the counter is a wireless communication device having a memory.

3. The method of claim 2, wherein:
the counter contains an RFID tag.

4. The method of claim 3, wherein:
the counter also carries a graphic promotional message.

5. The method of claim 2, wherein:
the memory is transient.

6. The method of claim 2, wherein:
the memory is ephemeral.

7. The method of claim 2, wherein:
the counter is configured to be interpreted by the interface as a command to open an application on the user's machine.

8. The method of claim 7, wherein:
the counter is configured to be interpreted by the interface and a control program for the interface as another command to the operating system on the user's machine.

9. The method of claim 1, further comprising the step of:
using a server directly identified by a first URL contained within a control program associated with the interface to distribute data to a user's machine or to redirect the request to a different URL.

10. The method of claim 9, wherein:
the counter is configured with ancillary data that is used by the first URL to determine what data to distribute to a user's machine or to which different URL to redirect the request.

11. The method of claim 9, wherein:
the counter is configured with data that is used by the different URL.

12. A physical user interface for a microprocessor device that runs an operating system, comprising:
an array of sensors located below a workspace having a housing;
the workspace divided into regions that are visible to a user, each region signifying a command to or an action performed by the operating system;
one or more counters that are uniquely identifiable by the sensors, each sensor producing a recognition signal;
a signal processor for determining, from the recognition signal, the identity of a counter and the region that counter is in and producing an associated first output;
a control program for turning the first output into a second output that is capable of being interpreted by the operating system as a command;
the housing having physical features for mechanically interlocking with and thus retaining a plurality of like counters.

13. The physical user interface of claim 12, wherein:
the sensors are RFID antennae and the counter contains a RFID tag and the command is one that relates to the organisation of a desktop of a graphical user interface.

14. The physical user interface of claim 12, wherein:
the counter identifies, to the operating system, a specific executable program and the command relates to the specific program.

15. The physical user interface of claim 12, wherein:
the counter has a memory that carries data that may be read by the interface, the data being provided by the control program to the operating system and then usable as input data to the specific executable program.

16. The physical user interface of claim 16, wherein:
the command is one that relates to the size or position of a window in a graphical user interface and is one selected from the group comprising: open, close, restore, scroll, move, re-size, minimise or maximise.

17. The method of claim 7, wherein:
the counter is configured with data that is used by an application on the user's machine.

18. The physical user interface of claim 12, wherein:
the sensors are RFID antennae and the counter contains a RFID tag and the command is one that relates to the presentation on the user's machine of data stored on the tag.

19. The method of claim 1, wherein:
the counter is of a kind having a memory that can be written to and the interface can write to the memory.

20. The interface of claim 12, wherein:
at least one counter has a memory that can be written to by the interface and the interface can write to the memory.
